(19) United States
(12) Patent Application Publication
(10) Pub. No.: US 2025/0103395 A1
(43) Pub. Date: Mar. 27, 2025

(54) SYSTEMS AND METHODS FOR DYNAMIC RESOURCE MANAGEMENT

(71) Applicant: Advanced Micro Devices, Inc., Santa Clara, CA (US)

(72) Inventors: Bradford Beckmann, Bellevue, WA (US); Matthew David Sinclair, Bellevue, WA (US); Vinay Bharadwaj Ramakrishnaiah, Bellevue, WA (US); William Peter Ehrett, Austin, TX (US)

(73) Assignee: Advanced Micro Devices, Inc., Santa Clara, CA (US)

(21) Appl. No.: 18/476,071

(22) Filed: Sep. 27, 2023

(51) Int. Cl. G06F 9/50

(52) U.S. Cl. CPC G06F 9/505; G06F 9/5061

(57) ABSTRACT

A computer-implemented method for dynamic resource management can include evaluating, by at least one processor, whether a priority of one or more processes associated with a request for one or more shared resources meets a threshold condition. The method can additionally include determining, by the at least one processor and in response to an evaluation that the priority meets the threshold condition, whether the one or more shared resources is available to meet the request. The method can further include completing, by the at least one processor and in response to a determination that the one or more shared resources is available, execution of the one or more processes. Various other methods, systems, and computer-readable media are also disclosed.

### BACKGROUND

Current graphics processing unit (GPU) resource allocation procedures must account for the worst-case resource needs of the workgroup. However, the immediate resource needs of a workgroup may vary significantly across its lifetime and often are much less than the maximum worse-case allocation. As a result, the number of workgroups assigned to a compute unit (CU) and able to concurrently execute is often less than the number that could fit if one considers the immediate needs of the workgroups, rather than their worst-case needs. This inefficiency results in reduced GPU throughput and resource utilization.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for dynamic resource management.

FIG. 2 is a block diagram of an additional example system for dynamic resource management.

FIG. 3 is a flow diagram of an example method for dynamic resource management.

FIG. 4 is a graphical illustration of thread live registers of different instructions.

FIG. 5 is a block diagram illustrating another example system for dynamic resource management in which monitor/mwait instructions cause an operation to wait until specific bits of a memory location are set before proceeding.

FIG. 6 is a flow diagram illustrating an example method of compiling instructions having programmer annotations indicating areas in a program in which a workgroup can benefit from additional resources and/or can safely temporarily relinquish its current resources.

FIG. 7 is a flow diagram illustrating an example method implementing a library algorithm for function calls.

FIG. 8 is a graphical illustration of example thresholds for relinquishing, reclaiming, and/or allocating resources.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for dynamic resource management. For example, by determining, in response to a priority of one or more processes associated with a request for one or more shared resources meeting a threshold condition, whether the one or more shared resources is available to meet the request, and completing, in response to a determination that the one or more shared resources is available, execution of the one or more processes, the disclosed systems and methods can simultaneously allocate compute unit (CU) resources between co-scheduled workgroups without deadlock, thus improving graphics processing unit (GPU) throughput and resource utilization.

The disclosed systems and methods can achieve the aforementioned advantageous outcomes in various ways. For example, in some implementations, the disclosed systems and methods can combine monitor/mwait instructions with dynamic register and local data store (LDS) allocation to provide an efficient library to coordinate the simultaneous allocation of CU resources between co-scheduled workgroups without deadlock. Monitor/mwait, dynamic vector general purpose registers (VGPR) allocation, and dynamic LDS allocation can be implemented in graphics processing units (GPUs). The disclosed systems and methods can combine these independent features to improve GPU throughput and resource utilization. For example, the disclosed systems and methods can combine efficient ticket lock implementations with programmer annotations to define areas in a program where a workgroup can benefit from additional resources and/or can safely temporarily relinquish its current resources. Example points of the program can be located before function calls for situations in which the wavefront is not holding a synchronization variable. In this way, the disclosed systems and methods enable individual workgroups (WGs) within persistent kernels to temporarily relinquish resources when they do not need them, thus allowing other WGs in the persistent kernel to utilize resources to improve performance and efficiency, without introducing deadlock.

In one example, a computer-implemented method can include determining, by at least one processor and in response to a priority of one or more processes associated with a request for one or more shared resources meeting a threshold condition, whether the one or more shared resources is available to meet the request, and completing, by the at least one processor and in response to a determination that the one or more shared resources is available, execution of the one or more processes.

Another example can be the previously described example method, further including evaluating, by the at least one processor, whether the priority meets the threshold condition, evaluating, by the at least one processor, whether an additional priority of one or more additional processes associated with an additional request for the one or more shared resources meets at least one of the threshold condition or one or more additional threshold conditions, determining, by the at least one processor and in response to an additional evaluation that the additional priority does not meet the at least one of the threshold condition or the one or more additional threshold conditions, whether a demand for the one or more shared resources meets a further threshold condition, and relinquishing, by the at least one processor and in response to an additional determination that the demand for the one or more shared resources meets the further threshold condition, one or more additional resources previously allocated to the one or more additional processes.

Another example can be any of the previously described example methods, further including reevaluating, by the at least one processor, whether the additional priority of the one or more additional processes meets at least one of the threshold condition or the one or more additional threshold conditions.

Another example can be any of the previously described example methods, further including reallocating, by the at least one processor in response to a reevaluation that the additional priority of the one or more additional processes meets the at least one of the threshold condition or the one or more additional threshold conditions, the one or more additional resources to the one or more additional processes.

Another example can be any of the previously described example methods, further including determining, by the at least one processor and in response to a reevaluation that the priority meets the threshold condition, whether the one or more shared resources is available to meet the additional request, and completing, by the at least one processor and in response to a further determination that the one or more shared resources is available, execution of the one or more additional processes.

Another example can be any of the previously described example methods, wherein completing the execution includes reallocating, by the at least one processor in response to the further determination that the one or more shared resources is available, the one or more additional resources to the one or more additional processes.

Another example can be any of the previously described example methods, wherein completing the execution includes allocating, by the at least one processor and in response to the determination that the one or more shared resources is available, the one or more shared resources to the one or more processes.

Another example can be any of the previously described example methods, wherein the further threshold condition corresponds to a number of wavefronts in a workgroup waiting for the one or more shared resources.

Another example can be any of the previously described example methods, wherein the priority is comparable to an additional priority of one or more additional processes requiring access to a same shared variable as the one or more processes.

Another example can be any of the previously described example methods, wherein the one or more shared resources corresponds to at least part of a local data store that serves as a scratchpad that allows communication between wavefronts in a workgroup.

Another example can be any of the previously described example methods, wherein the threshold condition corresponds to at least one of an assignment of an in order assignment synchronization mechanism, a place in line in a ticket lock synchronization mechanism, or a defined probability of usefulness of the one or more processes.

Another example can be any of the previously described example methods, wherein the determining and the completing occur in response to one or more library calls inserted by a compiler based on one or more annotations indicating that one or more function calls can be safely descheduled.

In one example, a computing device can include determination circuitry configured to determine, in response a priority of one or more processes associated with a request for one or more shared resources meeting a threshold condition, whether the one or more shared resources is available to meet the request, and execution circuitry configured to complete, in response to a determination that the one or more shared resources is available, execution of the one or more processes.

Another example can be the previously described example computing device, further including evaluation circuitry configured to evaluate whether the priority meets the threshold condition and whether an additional priority of one or more additional processes associated with an additional request for the one or more shared resources meets at least one of the threshold condition or one or more additional threshold conditions, wherein the determination circuitry is further configured to determine, in response to an additional evaluation that the additional priority does not meet the at least one of the threshold condition or the one or more additional threshold conditions, whether a demand for the one or more shared resources meets a further threshold condition, and relinquish, in response to an additional determination that the demand for the one or more shared resources meets the further threshold condition, one or more additional resources previously allocated to the one or more additional processes.

Another example can be any of the previously described example computing devices, wherein the evaluation circuitry is further configured to reevaluate whether the additional priority of the one or more additional processes meets at least one of the threshold condition or the one or more additional threshold conditions.

Another example can be any of the previously described example computing devices, wherein the determination circuitry is further configured to reallocate, in response to a reevaluation that the additional priority of the one or more additional processes meets the at least one of the threshold condition or the one or more additional threshold conditions, the one or more additional resources to the one or more additional processes.

Another example can be any of the previously described example computing devices, wherein the determination circuitry is further configured to determine, in response to a reevaluation that the priority meets the threshold condition, whether the one or more shared resources is available to meet the additional request, and the execution circuitry is further configured to complete, in response to a further determination that the one or more shared resources is available, execution of the one or more additional processes.

Another example can be any of the previously described example computing devices, wherein the execution circuitry is configured to complete the execution at least in part by reallocating, in response to the further determination that the one or more shared resources is available, the one or more additional resources to the one or more additional processes.

Another example can be any of the previously described example computing devices, wherein the execution circuitry is configured to complete the execution at least in part by allocating, in response to the determination that the one or more shared resources is available, the one or more shared resources to the one or more processes.

In one example, a system can include at least one physical processor, and physical memory comprising computer-executable instructions that, when executed by the at least one physical processor, cause the at least one physical processor to determine, in response to a priority of one or more processes associated with a request for one or more shared resources meeting a threshold condition, whether the one or more shared resources is available to meet the request, and complete, in response to a determination that the one or more shared resources is available, execution of the one or more processes.

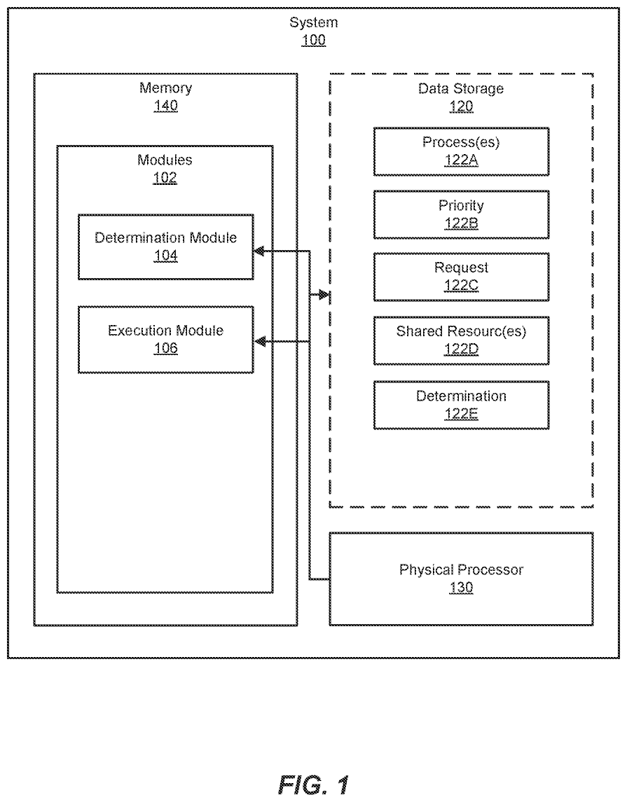

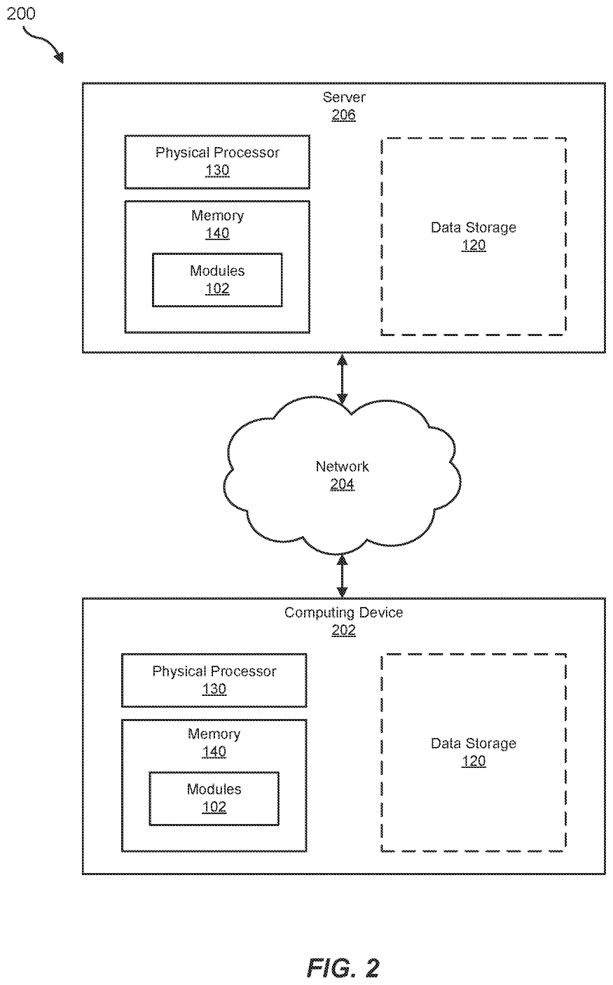

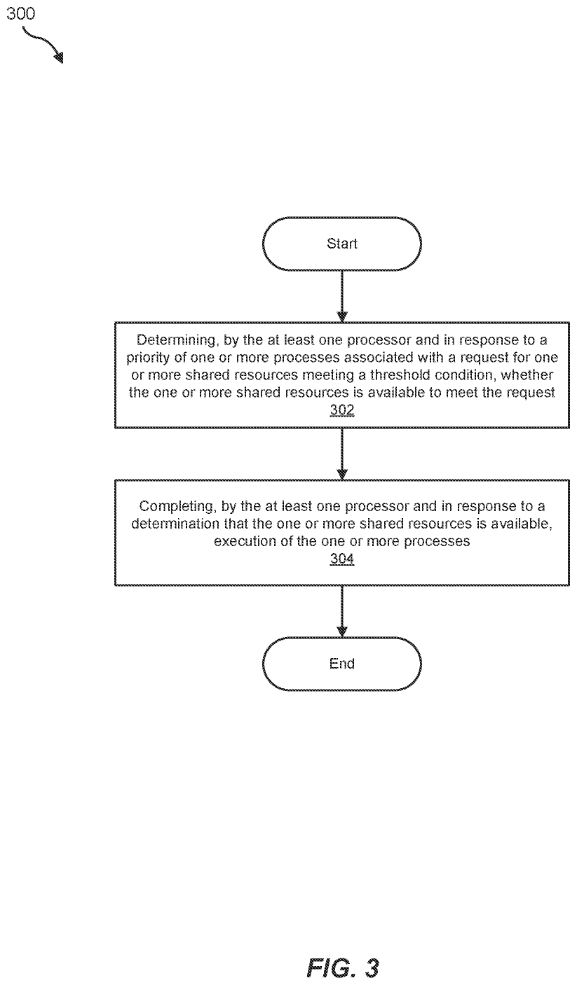

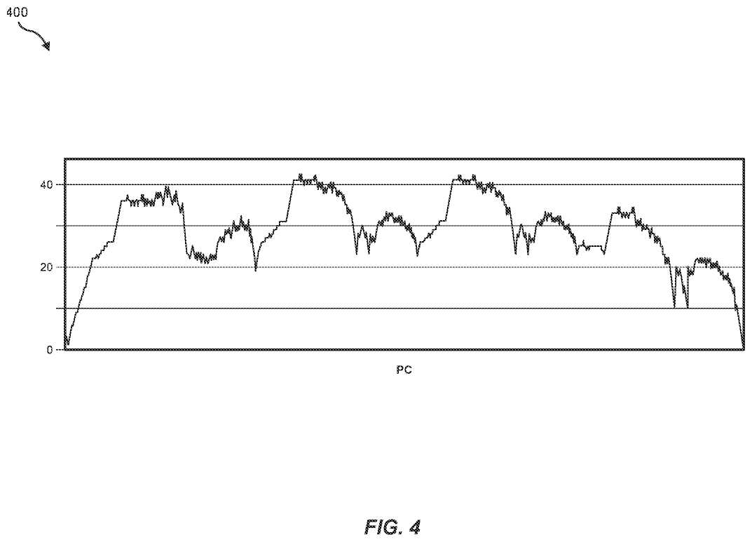

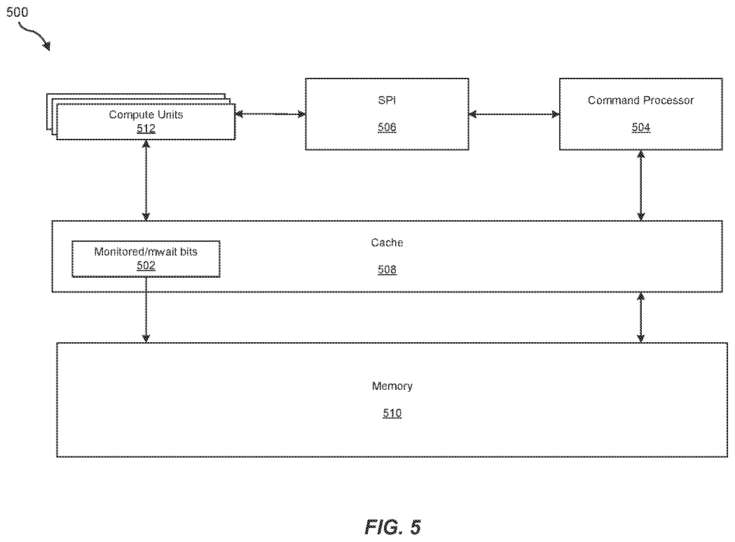

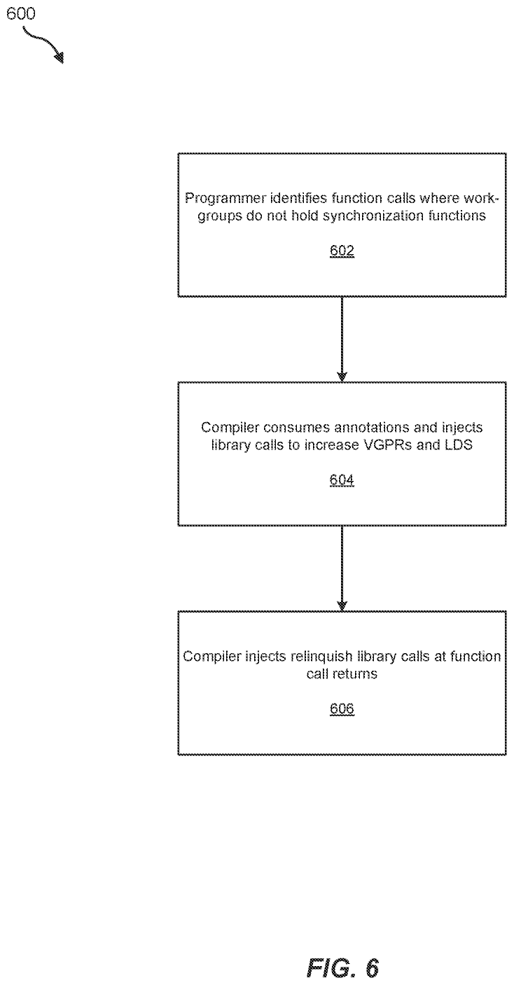

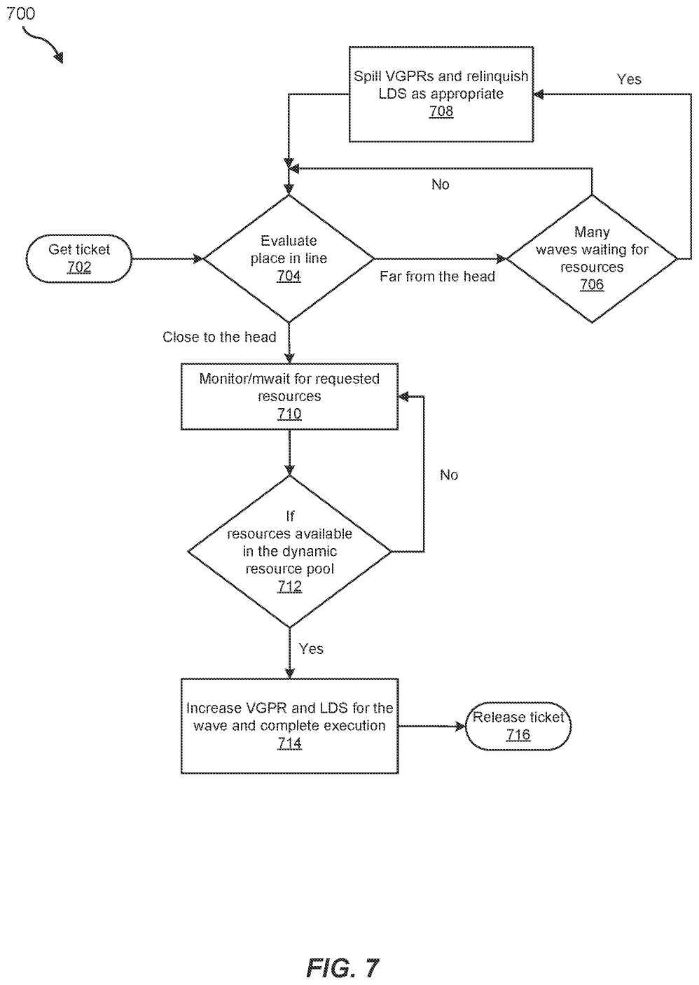

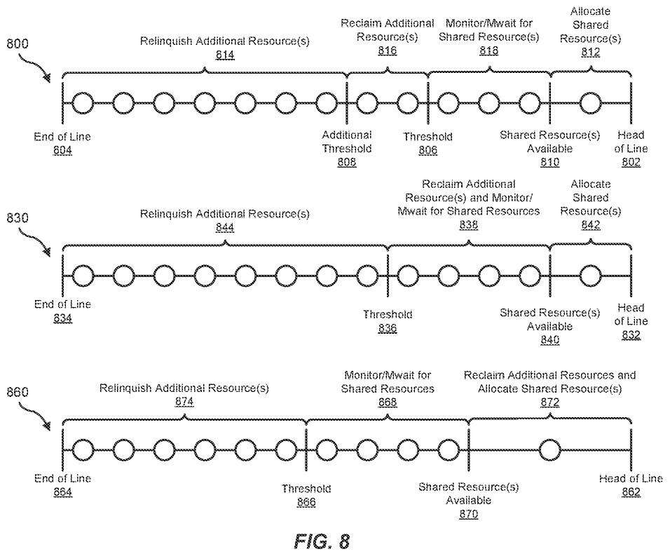

The following will provide, with reference to FIGS. 1-2, detailed descriptions of example systems for dynamic resource management. Detailed descriptions of corresponding computer-implemented methods will also be provided in connection with FIG. 3. In addition, detailed descriptions of example thread live registers of different instructions will be provided in connection with FIG. 4. In addition, detailed descriptions of another example system for dynamic resource management in which monitor/mwait instructions causes an operation to wait until specific bits of a memory location are set before proceeding will be provided in connection with FIG. 5. Further, detailed descriptions of an example method of compiling instructions having programmer annotations indicating areas in a program in which a workgroup can benefit from additional resources and/or can safely temporarily relinquish its current resources will be provided in connection with FIG. 6. Yet further, detailed descriptions of an example method implementing a library algorithm for function calls will be provided in connection with FIG. 7. Further still, detailed descriptions of example thresholds for relinquishing, reclaiming, and/or allocating resources will be provided in connection with FIG. 8.

FIG. 1 is a block diagram of an example system 100 for dynamic resource management. As illustrated in this figure, example system 100 can include one or more modules 102 for performing one or more tasks. As will be explained in greater detail below, modules 102 can include a determination module 104 and an execution module 106. Although illustrated as separate elements, one or more of modules 102 in FIG. 1 can represent portions of a single module or application.

The term “modules,” as used herein, can generally refer to one or more functional components of a computing device. For example, and without limitation, a module or modules can correspond to hardware, software, or combinations thereof. In turn, hardware can correspond to analog circuitry, digital circuitry, communication media, or combinations thereof.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate dynamic resource management. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more instances of stored data, such as data storage 120. Data storage 120 generally represents any type or form of stored data, however stored (e.g., signal line transmissions, bit registers, flip flops, software in rewritable memory, configurable hardware states, combinations thereof, etc.). In one example, data storage 120 includes databases, spreadsheets, tables, lists, matrices, trees, or any other type of data structure. Examples of data storage 120 include, without limitation, processes 122A, priority 122B, request 122C, shared resource(s) 122D, and/or determination 122E.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to dynamically manage resources.

Computing device 202 generally represents any type or form of computing device capable of reading computer-executable instructions. In some implementations, computing device 202 can be and/or include a graphics processing unit having a chiplet processor connected by a switch fabric. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 206 generally represents any type or form of computing device that is capable of reading computer-executable instructions. In some implementations, computing device 202 can be and/or include a cloud service (e.g., cloud gaming server) that includes a graphics processing unit having a chiplet processor connected by a switch fabric. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for dynamic resource management. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

The term “computer-implemented method,” as used herein, can generally refer to a method performed by hardware or a combination of hardware and software. For example, hardware can correspond to analog circuitry, digital circuitry, communication media, or combinations thereof. In some implementations, hardware can correspond to digital and/or analog circuitry arranged to carry out one or more portions of the computer-implemented method. In some implementations, hardware can correspond to physical processor 130 of FIG. 1. Additionally, software can correspond to software applications or programs that, when executed by the hardware, can cause the hardware to perform one or more tasks that carry out one or more portions of the computer-implemented method. In some implementations, software can correspond to one or more of modules 102 stored in memory 140 of FIG. 1.

As illustrated in FIG. 3, at step 302 one or more of the systems described herein can determine shared resource availability. For example, determination module 104 can, as part of computing device 202 in FIG. 2, determine, by the at least one processor and in response to a priority of one or more processes associated with a request for one or more shared resources meeting a threshold condition, whether the one or more shared resources is available to meet the request.

The term “priority,” as used herein, can generally refer to the right to take precedence or proceed before others. For example, and without limitation, example priorities can include a place in line, a probability of usefulness, and/or a random selection.

The term “process,” as used herein, can generally refer to a series of actions or steps taken in order to achieve a particular end. For example, and without limitation, example processes can include software threads, wavefronts, and/or master threads for workgroups. In this context, a wavefront (e.g., warp) can be a collection of operations that execute in lockstep, run the same instructions, and follow the same flow control path. In this context, a thread can be a work item that can correspond to an individual lane in a wavefront. Such work items can run in lockstep with other work items in the wavefront, with respect to which individual lanes can be masked off. In this context, a workgroup can be a thread block that corresponds to a group of wavefronts co-scheduled on a GPU. This group of wavefronts can synchronize and communicate through local memory.

The term “shared resource,” as used herein, can generally refer to hardware and/or software that makes up a computer system and/or any software or device that can be accessed from that computer system. For example, and without limitation, shared resources can refer to compute units and/or local memory. In this context, the term “compute unit” can generally refer to one or many parallel vector processors in a GPU that contain parallel arithmetic logic units (ALUs). All wavefronts in a workgroup can be assigned to a same compute unit. Also in this context, local memory can be used by wavefronts and/or workgroups to communicate with one another. Local memory can be local data storage, shared memory, and/or a scratchpad that allows communication between wavefronts in a workgroup, etc. In contrast, private memory can correspond to per-thread private memory often mapped to local registers. Likewise, global memory is memory (e.g., DRAM) accessible by the GPU that goes through the same layers of cache.

The term “request,” as used herein, can generally refer to a message sent between objects. For example, and without limitation, a request for shared resources can include data and/or amount of data to be copied to an address corresponding to a shared resource.

The term “threshold condition,” as used herein, can generally refer to a defined status of an attribute based on specific conditions. For example, and without limitation, a threshold condition can correspond to a level of priority. In this context, the level of priority can correspond to a place in line, a probability of usefulness, a random selection, etc.

The systems described herein can perform step 302 in a variety of ways. In one example, determination module 104 can include an evaluation module that can evaluate the priority. For example, the evaluation module can, as part of computing device 202 in FIG. 2, evaluate, by at least one processor, whether a priority of one or more processes associated with a request for one or more shared resources meets a threshold condition.

The systems described herein can perform the evaluation in a variety of ways. For example, the one or more shared resources can correspond to at least part of a local data store that serves as a scratchpad that allows communication between wavefronts in a workgroup. Additionally or alternatively, the priority can be comparable to an additional priority of one or more additional processes requiring access to a same shared variable as the one or more processes. Additionally or alternatively, the threshold condition can correspond to an assignment of an in order assignment synchronization mechanism, a place in line in a ticket lock synchronization mechanism, and/or a defined probability of usefulness of the one or more processes. In one example, the evaluation module can, as part of computing device 202 in FIG. 2, evaluate, by the at least one processor, whether an additional priority of one or more additional processes associated with an additional request for the one or more shared resources meets at least one of the threshold condition or one or more additional threshold conditions. In some of these examples, the evaluation module can, as part of computing device 202 in FIG. 2, reevaluate, by the at least one processor, whether the additional priority of the one or more additional processes meets at least one of the threshold condition or the one or more additional threshold conditions.

The systems described herein can perform step 302 in additional ways. In one example, determination module 104 can, as part of computing device 202 in FIG. 2, determine, by the at least one processor and in response to an additional evaluation that the additional priority does not meet the at least one of the threshold condition or the one or more additional threshold conditions, whether a demand for the one or more shared resources meets a further threshold condition. In some of these examples, determination module 104 can, as part of computing device 202 in FIG. 2, determine, by the at least one processor and in response to a reevaluation that the priority meets the threshold condition, whether the one or more shared resources is available to meet the additional request. In some of these examples, the further threshold condition can correspond to a number of wavefronts in a workgroup waiting for the one or more shared resources.

At step 304 one or more of the systems described herein can complete execution. For example, execution module 106 can, as part of computing device 202 in FIG. 2, complete, by the at least one processor and in response to a determination that the one or more shared resources is available, execution of the one or more processes.

The systems described herein can perform step 304 in a variety of ways. In one example, execution module 106 can, as part of computing device 202 in FIG. 2, relinquish, by the at least one processor and in response to an additional determination that the demand for the one or more shared resources meets the further threshold condition, one or more additional resources previously allocated to the one or more additional processes. In some of these examples, execution module 106 can, as part of computing device 202 in FIG. 2, reallocate, by the at least one processor in response to a reevaluation that the additional priority of the one or more additional processes meets the at least one of the threshold condition or the one or more additional threshold conditions, the one or more additional resources to the one or more additional processes. In some of these examples, execution module 106 can, as part of computing device 202 in FIG. 2, complete, by the at least one processor and in response to a further determination that the one or more shared resources is available, execution of the one or more additional processes. In some of these examples, execution module 106 can, as part of computing device 202 in FIG. 2, reallocate, by the at least one processor in response to the further determination that the one or more shared resources is available, the one or more additional resources to the one or more additional processes. In some of these examples, completion of the execution can include allocating, by the at least one processor and in response to the determination that the one or more shared resources is available, the one or more shared resources to the one or more processes. In additional or alternative examples, completing the execution can include allocating, by the at least one processor and in response to the determination that the one or more shared resources is available, the one or more shared resources to the one or more processes.

The procedures described above can be triggered in various ways. For example, the determining at step 302, and the completing at step 304 can occur in response to one or more library calls inserted by a compiler based on one or more annotations indicating that one or more function calls can be safely descheduled. Additional details regarding example annotation and compilations are provided later herein with reference to FIG. 6.

FIG. 4 illustrates thread live registers 400 of different instructions. Current GPU resource allocation procedures must account for the worst-case resource needs of the workgroup. However, as shown in FIG. 4, the immediate resource needs of a workgroup may vary significantly across its lifetime and often are much less than the maximum worse-case allocation. As a result, the number of workgroups assigned to a compute unit and able to concurrently execute is often less than the number that could fit if one considers the immediate needs of the workgroups, rather than their worst-case needs.

FIG. 5 is a block diagram illustrating another example system 500 for dynamic resource management in which monitor/mwait instructions cause an operation to wait until specific bits 502 of a memory location are set before proceeding. System 500 can include a command processor 504 in communication with a shader processor input controller 506, a cache 508 containing the specific bits 502, and a memory 510. One or more compute units 512 can be shared resources used by workgroups in a wavefront to communicate with one another.

As noted above, the number of workgroups assigned to a compute unit 512 and able to concurrently execute is often less than the number that could fit if one considers the immediate needs of the workgroups, rather than their worst-case needs. System 500 can alleviate this bottleneck and provide deadlock-free management of dynamically assigned registers and local data store (LDS) space. In some examples, system 500 can build on dynamic vector general purpose register (VGPR) allocation, which can use monitor/mwait instructions to place a wavefront into a waiting state. While dynamic VGPR allocation can place a single wavefront into a waiting state for registers, it does not check whether other wavefronts within a workgroup may also be waiting for additional registers. Nor does dynamic VGPR allocation handle simultaneously waiting for additional LDS space.

System 500 can leverage the monitor/mwait-type behavior in GPUs by extending this feature to track multiple wavefronts within a workgroup and multiple workgroups within a compute unit 512. By doing so, system 500 can allow GPU compute units 512 to enhance their dynamic LDS/VGPR allocations. Monitor/mwait instructions can allow a thread to go to sleep and relinquish its execution resources until a synchronization variable is updated and meets a specified condition. In GPUs, this feature can be useful because many simultaneously scheduled wavefronts compete for finite compute unit 512 execution resources and current wave schedulers are unaware if a wavefront is making forward progress or stuck waiting for some condition to be met before it can make forward progress. System 500 allows the system to ensure that the scheduled wavefronts have the necessary resources to make forward progress. System 500 can achieve this objective by descheduling (e.g., putting to sleep) all wavefronts that are waiting for additional resources to become available, thus freeing up those resources to be used by other wavefronts that are making forward progress.

FIG. 6 is a flow diagram illustrating an example method 600 of compiling instructions having programmer annotations indicating areas in a program in which a workgroup can benefit from additional resources and/or can safely temporarily relinquish its current resources. Method 600 can entail a coordinated process between a programmer, a compiler, and a runtime library that supports dynamic expansion and contraction of per-workgroup resources. Method 600 provides an example assuming that function calls are portions of the code where additional resources are needed. However, the disclosed systems and methods do not require this to be the case and an alternative approach can rely on the programmer using resource profiling to identify portions of the code that use a significant number of registers.

At step 602, the programmer can add annotations (e.g., one or more predefined programming language commands) just before function calls identifying whether the workgroup holds any synchronization variables or is safe to be descheduled without causing deadlock. For example, the programmer can identify areas of the code that do not contain synchronization functions and annotate them appropriately. Providing appropriate annotations can prevent deadlock from occurring between workgroups waiting for resources and workgroups waiting for synchronization.

At step 604, the deadlock-free annotations can be used by the compiler to identify portions of the code where it should determine separate upper resource limits and inject library calls. For example, the compiler can, at step 604, inject library calls to increase VGPRs and LDS. An application can aid this process by providing additional information to the compiler in the form of launch bounds, LDS size, and maximum register count at the annotations. The compiler can use this information to estimate the resource requirements of each wavefront. Once the compiler identifies the resource needs for separate portions of the code, it can pass that information to the runtime using a predefined set of application programming interfaces (APIs).

Upon receiving the information passed by the compiler, the runtime can track the total number of VGPRs and the LDS size required by each wavefront in a workgroup at any point. Additionally, the runtime can manage a dynamic resource pool, which keeps track of the available resources per wave in addition to the total resource availability. When the execution transitions to portions of the code with less resource needs (e.g., a function call return), the compiler can, at step 606, insert a “relinquish resource” library call and any resources relinquished by the workgroup can be added back to the total available resource count. In addition, when a workgroup completes, it can first relinquish its resources to the runtime in case other workgroups of the kernel are waiting for resources, before giving resources back to the hardware for the next kernel launch.

FIG. 7 is a flow diagram illustrating an example method 700 implementing a library algorithm for function calls. Method 700 can use in-order assignment of resources to waiting wavefronts, ensuring that forward progress is maintained. Modern GPU libraries efficiently implement in-order assignment through numerous techniques. One such technique is a ticket lock, in which each thread or, in some cases, a “master” thread per workgroup obtains, at 702, a ticket specifying the thread's place in line to access a shared variable (e.g., using a critical section). Method 700 integrates well with these libraries. Software hints about relinquishing resources can, at 704, utilize information about how far away the thread is from reaching the head of the line to determine when resources should be relinquished. For example, if it is determined, at 706, that there are many other threads ordered before a given thread in the ticket lock, this thread should relinquish its resources, at 708, because it will not be able to make forward progress for a while. Similarly, when it is determined, at 704, that the thread gets close to the front of the line, it can reclaim its resources since it will be able to make forward progress soon.

Method 700 is described above in the context of a ticket lock mechanism. However, method 700 can utilize additional or alternative approaches to priority, such as assigning a probability of usefulness to waves and processing them in the order of the assigned probabilities. For example, wavefronts of kernels launched with hipStreamCreateWithPriority can be assigned the same priority as the stream to which they belong when co-scheduling waves from different streams. Alternatively or additionally, wavefronts holding relatively larger amounts of additional resources compared to other co-scheduled wavefronts can be assigned lower priorities to cause those wavefronts to relinquish the larger amounts of additional resources and speed forward progress. Also, priorities can be assigned randomly to co-scheduled wavefronts competing for shared resources.

The process for expanding LDS size can be performed by waiting, at 710, for continuous space for the full allocation. Then, if it is determined, at 712, that the resources are available, the existing data can be copied, at 714, into the new larger space. This approach allows for a single work-group pointer to be used to offset into the physical LDS space. Alternatively, with some additional hardware support, the extended LDS space can be supported by additional bounds registers and offset pointers so that LDS references seamlessly access the correct physical locations. This hardware can be the same or similar to hardware currently used to manage the allocation of multiple chunks of VGPRs. Once the execution is completed at 714, the ticket and the resources can be released at 716.

FIG. 8 is a graphical illustration of example thresholds for relinquishing, reclaiming, and/or allocating resources. In wavefront queues 800, 830, and 860, wavefronts can have priorities that can correspond to their positions in a line. The queues 800, 830, and 860 can be operated various ways depending on priority types. For example, a ticket lock mechanism can be accomplished utilizing a first in, first out, basis of operation in which wavefronts enter the line at the end of the line 804, 834, and 864 and exit at the head of the line 802, 832, and 862. Additionally, a probability of usefulness implementation can be accomplished by wavefronts entering the line at a position according to their assigned probability of usefulness and exiting at the head of the line 802, 832, and 862. Also, randomized implementation can be accomplished by wavefronts entering the line at a randomly determined position and exiting at the head of the line 802, 832, and 862.

Various thresholds for relinquishing resources, reclaiming resources, and/or allocating resources can be dynamically determined based on various factors, such as priority type, a number of wavefronts in the line, a rate of forward progress, etc. For example, wavefront queue 800 can have a threshold 806, an additional threshold 808, and a point 810 at which additional resources become available. Threshold 806 can be defined as a level of priority that is lower than the point 810 at which resources become available and can be used to determine when one or more wavefronts should begin monitoring for shared resources at 818. For example, wavefronts having priorities (e.g., places in line) above threshold 806 can monitor for the shared resources until they become available at point 810, at which point the available resources can be allocated at 812. In contrast, additional threshold 808 can be defined as a level of priority that is lower than the level of priority of threshold 806 and can be used to determine when wavefronts should relinquish additional resources at 814 and/or reclaim the additional resources at 816. For example, wavefronts having priorities (e.g., places in line) below threshold 808 can relinquish the additional resources at 814 and wavefronts having priorities (e.g., places in line) above threshold 808 can reclaim the additional resources at 816.

Wavefront queue 830 can have a threshold 836 and a point 840 at which additional resources become available. Threshold 836 can be defined as a level of priority that is lower than the point 840 at which resources become available and can be used to determine when one or more wavefronts should both reclaim additional resources and begin monitoring for shared resources at 838. For example, wavefronts having priorities (e.g., places in line) above threshold 836 can, at 838, both reclaim additional resources and monitor for the shared resources until they become available at point 840, at which point the available resources can be allocated at 842. Additionally, threshold 836 can be used to determine when wavefronts should relinquish additional resources at 844. For example, wavefronts having priorities (e.g., places in line) below threshold 836 can relinquish the additional resources at 844.

Wavefront queue 860 can have a threshold 866 and a point 870 at which additional resources become available. Threshold 866 can be defined as a level of priority that is lower than the point 870 at which resources become available and can be used to determine when one or more wavefronts begin monitoring for shared resources at 868. For example, wavefronts having priorities (e.g., places in line) above threshold 866 can, at 868, monitor for the shared resources until they become available at point 870, at which point those wavefronts can reclaim additional resources and the available resources can be allocated at 872. Additionally, threshold 866 can be used to determine when wavefronts should relinquish the additional resources at 874. For example, wavefronts having priorities (e.g., places in line) below threshold 866 can relinquish the additional resources at 874.

As set forth above, the disclosed systems and methods for dynamic resource management can evaluate whether a priority of one or more processes associated with a request for one or more shared resources meets a threshold condition, determine whether the one or more shared resources is available to meet the request, and complete execution of the one or more processes. In this way, the disclosed systems and methods can simultaneously allocate compute unit (CU) resources between co-scheduled workgroups without deadlock, thus improving graphics processing unit (GPU) throughput and resource utilization.

In some examples, the disclosed systems and methods can combine monitor/mwait instructions with dynamic register and LDS allocation to provide an efficient library to coordinate the simultaneous allocation of CU resources between co-scheduled workgroups without deadlock. These independent features can be effectively combined to maximize GPU throughput and resource utilization. In some examples, the disclosed systems and methods combine concepts from efficient ticket lock implementations with programmer annotations to define areas in a program where a workgroup may need additional resources or may safely temporarily relinquish its current resources. These points of the program can be located before function calls and can correspond to situations where the wavefront is not holding a synchronization variable. These and other features disclosed herein can be implemented to the benefit of any architectures running co-scheduled workloads on a device, wherein low-level execution resources must be shared between workloads. These architectures can include GPUs, central processing units (CPUs), accelerator-rich systems on chip (SoCs), multi-chiplet pipelines, and other architectures in which low-level execution resource allocation can be carefully managed to avoid deadlock.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
determining, by at least one processor and in response to a priority of one or more processes associated with a request for one or more shared resources meeting a threshold condition, whether the one or more shared resources is available to meet the request; and
completing, by the at least one processor and in response to a determination that the one or more shared resources is available, execution of the one or more processes.

2. The computer-implemented method of claim 1, further comprising:
evaluating, by the at least one processor, whether the priority meets the threshold condition;
evaluating, by the at least one processor, whether an additional priority of one or more additional processes associated with an additional request for the one or more shared resources meets at least one of the threshold condition or one or more additional threshold conditions;
determining, by the at least one processor and in response to an additional evaluation that the additional priority does not meet the at least one of the threshold condition or the one or more additional threshold conditions, whether a demand for the one or more shared resources meets a further threshold condition; and
relinquishing, by the at least one processor and in response to an additional determination that the demand for the one or more shared resources meets the further threshold condition, one or more additional resources previously allocated to the one or more additional processes.

3. The computer-implemented method of claim 2, further comprising:
reevaluating, by the at least one processor, whether the additional priority of the one or more additional processes meets at least one of the threshold condition or the one or more additional threshold conditions.

4. The computer-implemented method of claim 3, further comprising:
reallocating, by the at least one processor in response to a reevaluation that the additional priority of the one or more additional processes meets the at least one of the threshold condition or the one or more additional threshold conditions, the one or more additional resources to the one or more additional processes.

5. The computer-implemented method of claim 3, further comprising:
determining, by the at least one processor and in response to a reevaluation that the priority meets the threshold condition, whether the one or more shared resources is available to meet the additional request; and
completing, by the at least one processor and in response to a further determination that the one or more shared resources is available, execution of the one or more additional processes.

6. The computer-implemented method of claim 5, wherein completing the execution includes:
reallocating, by the at least one processor in response to the further determination that the one or more shared resources is available, the one or more additional resources to the one or more additional processes.

7. The computer-implemented method of claim 5, wherein completing the execution includes:
allocating, by the at least one processor and in response to the determination that the one or more shared resources is available, the one or more shared resources to the one or more processes.

8. The computer-implemented method of claim 2, wherein the further threshold condition corresponds to a number of wavefronts in a workgroup waiting for the one or more shared resources.

9. The computer-implemented method of claim 1, wherein the priority is comparable to an additional priority of one or more additional processes requiring access to a same shared variable as the one or more processes.

10. The computer-implemented method of claim 1, wherein the one or more shared resources corresponds to at least part of a local data store that serves as a scratchpad that allows communication between wavefronts in a workgroup.

11. The computer-implemented method of claim 1, wherein the threshold condition corresponds to at least one of:
an assignment of an in order assignment synchronization mechanism;
a place in line in a ticket lock synchronization mechanism; or
a defined probability of usefulness of the one or more processes.

12. The computer-implemented method of claim 1, wherein the determining and the completing occur in response to one or more library calls inserted by a compiler based on one or more annotations indicating that one or more function calls can be safely descheduled.

13. A computing device, comprising:
determination circuitry configured to determine, in response to a priority of one or more processes associated with a request for one or more shared resources meeting a threshold condition, whether the one or more shared resources is available to meet the request; and
execution circuitry configured to complete, in response to a determination that the one or more shared resources is available, execution of the one or more processes.

14. The computing device of claim 13, further comprising:
evaluation circuitry configured to evaluate whether the priority meets the threshold condition and whether an additional priority of one or more additional processes associated with an additional request for the one or more shared resources meets at least one of the threshold condition or one or more additional threshold conditions,
wherein the determination circuitry is further configured to:
determine, in response to an additional evaluation that the additional priority does not meet the at least one of the threshold condition or the one or more additional threshold conditions, whether a demand for the one or more shared resources meets a further threshold condition; and
relinquish, in response to an additional determination that the demand for the one or more shared resources meets the further threshold condition, one or more additional resources previously allocated to the one or more additional processes.

15. The computing device of claim 14, wherein the evaluation circuitry is further configured to reevaluate whether the additional priority of the one or more additional processes meets at least one of the threshold condition or the one or more additional threshold conditions.

16. The computing device of claim 15, wherein the determination circuitry is further configured to reallocate, in response to a reevaluation that the additional priority of the one or more additional processes meets the at least one of the threshold condition or the one or more additional threshold conditions, the one or more additional resources to the one or more additional processes.

17. The computing device of claim 15, wherein:
the determination circuitry is further configured to determine, in response to a reevaluation that the priority meets the threshold condition, whether the one or more shared resources is available to meet the additional request; and
the execution circuitry is further configured to complete, in response to a further determination that the one or more shared resources is available, execution of the one or more additional processes.

18. The computing device of claim 17, wherein the execution circuitry is configured to complete the execution at least in part by reallocating, in response to the further determination that the one or more shared resources is available, the one or more additional resources to the one or more additional processes.

19. The computing device of claim 17, wherein the execution circuitry is configured to complete the execution at least in part by allocating, in response to the determination that the one or more shared resources is available, the one or more shared resources to the one or more processes.

20. A system comprising:
at least one physical processor; and
physical memory comprising computer-executable instructions that, when executed by the at least one physical processor, cause the at least one physical processor to:
determine, in response to a priority of one or more processes associated with a request for one or more shared resources meeting a threshold condition, whether the one or more shared resources is available to meet the request; and
complete, in response to a determination that the one or more shared resources is available, execution of the one or more processes.
